(19) United States
(12) Patent Application Publication
(10) Pub. No.: US 2023/0264217 A1
(43) Pub. Date: Aug. 24, 2023

(54) AUTOMATIC DISPENSER OF FLUID PRODUCTS CONTAINED IN CARTRIDGES, CARTRIDGE, EJECTION NOZZLE AND IMPLEMENTATION METHOD

(71) Applicants: Christophe HORVATH, Bons-en-Chablais (FR); Adrien PLECIS, Cachan (FR); LINKEDTECH, Paris (FR)

(72) Inventors: Christophe HORVATH, Bons-en-Chablais (FR); Adrien PLECIS, Surgères (FR)

(21) Appl. No.: 18/014,218

(22) PCT Filed: Jul. 12, 2021
(86) PCT No.: PCT/EP2021/069345

§ 371 Date: Jan. 3, 2023

(30) Foreign Application Priority Data
Jul. 12, 2020 (FR) FR2007375

(51) Int. Cl. B05B 11/00; B05B 1/34; B01F 33/84

(52) U.S. Cl. CPC B05B 11/0078; B05B 11/0054; B05B 1/34; B01F 33/844; B01F 2101/06

(57) ABSTRACT

The invention relates to an automatic dispenser (100) of fluid products contained in cartridges, these being able to accommodate a large number of large-capacity cartridges while having reduced over-inking. The dispenser comprises: a frame provided with N slots (E) for cartridges (200A, 200B, 200C) of products, these cartridges being each provided with a reservoir and with a metering pump; an actuation system (30) for the cartridges, comprising: a motor (31) that is able to generate a force for actuating the metering pump of the cartridges; a selective transmission mechanism (32) that is able to selectively transmit the force generated by the motor to at least one of the metering pumps; a recess for a removable container; the N slots (E) being arranged substantially horizontally and in a stepped manner.

The invention relates to an automatic dispenser of fluid products contained in cartridges, in particular for the extemporaneous and personalised preparation of a mixture of products from a plurality of cartridges, for example, but not exclusively, in the field of food additives.

The invention also relates to a cartridge and to an injection nozzle enabling ejection of the product when the cartridge is substantially horizontal, as well as a method of use.

The health and cosmetics industries are increasingly tending to favor the personalisation of products as a function of the end user. This tendency is for example observed for the preparation of pharmaceutical treatments specifically adapted to the patient as a function of their sex, their age, their genetic heritage and specifics of their disease, such as their cancer or the viral strain.

This type of preoccupation also concerns the field of food additives in order to optimize the efficacy of those additives whilst limiting negative effects and/or overdoses, and adapting in real time the composition of the solution to the actual needs of the patient or of the consumer.

In order to enable personalised preparation of this kind there have already been proposed automatic dispensers including at least two cartridges of different components and a mechanical (syringe pusher type) or pneumatic pumping mechanism.

The patent document FR3044219 describes an automated device including a control interface controlling syringe drivers causing the injection of the content of the syringes into flexible tubes meeting in a mixing zone consisting of a multiple input connector connected to a cone for ejection of the cosmetic composition prepared in this way.

However, the use of syringe drivers makes the machine very costly, somewhat imprecise in terms of the volume dispensed, somewhat impractical when it comes to changing the reservoirs of products, and very bulky, because a great deal of space is required to enable retraction of the pistons. The footprint on the support is therefore very large.

The documents U.S. Pat. No. 10,022,741, NL1015747 and WO2016090235 describe two dispensers of products the cartridges of which are organized in the form of a vertical or substantially vertical barrel, that is to say the vertical cartridges are arranged around the vertical axis of the dispensing container. This arrangement has the disadvantage of a somewhat disadvantageous form factor: the dispenser thus takes the form of a vertically elongate cylinder the diameter of which soon becomes very large if the number of cartridges or the volume thereof is to be increased.

In fact, a cartridge with a volume of 100 mL generally has a minimum diameter of 40 mm and more generally a value close to 50 mm. If it is considered that the outlet is on the edge of the cartridge, that implies that the outlets are arranged on a diameter of 50 mm in a barrel configuration with 6 cartridges.

With 7 cartridges a barrel configuration makes possible outlets on a circle of approximately 65 mm diameter.

With 8 cartridges, a barrel configuration makes possible outlets on a circle of approximately 80 mm diameter.

Now, a small glass has a diameter of approximately 5 to 6 cm. It then becomes indispensable to use a nozzle if there are to be more than 6 cartridges in the device. However, a nozzle adds a dead volume that can be a source of error because of drying out of the liquid.

Moreover, the cylindrical form factor of the cartridges is also limiting with the concept of the document WO2016090235 and with the machine of the document U.S. Pat. No. 10,022,741. In fact, in the concept of the document WO2016090235, it the number of cartridges is to be increased beyond three, the result would necessarily be a machine that would no longer resemble a gourd and there would then be lost the mobility aspect that is one of the objectives of that document. This is even more of a problem in the case of the machine from the document U.S. Pat. No. 10,022,741 which uses cartridges of larger capacity.

Consequently, for an equivalent footprint, either preference is given to the number of cartridges and their size (and therefore their capacity) are reduced, as in the document WO2016090235, which generates much waste and risk of prescription errors, or preference is given to the capacity of the cartridges and the number thereof must be limited, possibly as in the document U.S. Pat. No. 10,022,741 by adapting their shape to limit the spaces between the cartridges, which decreases the number of possible combinations and increases the costs of manufacturing the cartridges.

On the other hand, the vertical barrel configuration described in the above two documents necessitates loading either from above, in which case it is necessary to move all of the mechanical units situated above the cartridges, or from the side, in which case there must either be provided a cover that extends all around the device so as to be able to change all the cartridges or a sliding barrel, which necessarily leads to a loss of precision in the positioning of the cartridges.

Finally, it is found in practise that all these dispensers rapidly become soiled when certain products are dispensed, in particular products containing particles that settle out (for example compositions including plant extracts for example). This leads to blocking of the nozzles, which either necessitates very regular maintenance which is generally not within the skillset of the user or a complex and costly automatic cleaning mechanism. Moreover, the particles that settle out are generally undesirable and dispensing them is to be avoided, which is not possible with dispensers before now.

On the other hand, these vertical dispensers are totally insensitive to the problem of products containing supernatant particles, generally also undesirable, as the latter are concentrated opposite the nozzle and do not risk being expelled by the nozzle or blocking it.

Moreover, the vertical barrel configuration is essential to allow localized dispensing of the products contained in the cartridges. In fact, this arrangement enables the outlets of each cartridge to be positioned one against the other, so that the products drop into a restricted perimeter zone. Accordingly, as explained in the document U.S. Pat. No. 10,022,741, the user can place their fingers under the cartridges to collect the dispensed cosmetic products.

The invention therefore has for objective proposing an economic automatic dispenser (that is to say one capable of using identical cartridges) automatic dispenser that is relatively compact (that is to say has a small footprint) whilst being able to contain numerous cartridges (that is to say at least six), of large capacity (that is to say at least 100 milliliters) to be able to dispense numerous different combinations of fluid products, without having to change the cartridges every day, multi-purpose (that is to say able to dispense without risk products liable to feature inhomogeneities—sedimentation or supernatation), limiting waste, and all this in a restricted dispensing zone with precise dosage by reproducible mechanical action of the dispenser on the cartridges.

Another objective is to facilitate the maintenance and the repair of the dispenser by favoring direct access to the various parts, in particular to the motor and to the transmission mechanism), without having to demount the cartridges and their support.

One of the ideas behind the invention is to propose a radically different arrangement of the cartridges by elongating them relative to the position of use. Accordingly, the body of the cartridges is essentially horizontal, so that the cartridges may be organized in height on a plurality of levels without increasing the footprint. In accordance with the invention, the cartridges are moreover offset axially, either structurally or functionally, that is to say when activated, so that their outlet is arranged above a container, which enables dispensing in a restricted zone, in particular in a container with a diameter of 6 cm, which is a classic glass diameter.

In this way, if the number of cartridges is increased the footprint of the machine on the support increases only very little, and only its height increases by substantially the diameter of a cartridge. There may therefore be up to 10 or even 15 cartridges of large volume directed directly into the container, which makes it possible to obtain a very large number of possible combinations.

This arrangement moreover allows direct access to the cartridges and loading from the front, which is a very important ergonomic advantage, in particular if the cartridges are changed by a non-professional. This organisation of the cartridges also makes it possible for the mechanism for actioning the cartridges to be arranged behind the cartridges, and therefore directly accessible via a rear cover, which facilitates maintenance.

The dispenser according to the invention is therefore simple, economic, with a small footprint and multi-purpose.

To be more precise, the invention has for object an automatic dispenser of fluid products contained in cartridges, the dispenser including:
a frame with N locations each having a longitudinal axis, N being an integer greater or equal to 2, the locations being intended, in use, to receive the cartridges of products each including a reservoir and a mechanical metering pump that can be activated in an axial actuation direction and includes a product ejection orifice;
a system for actuating the cartridges, including:
   a motor able to generate a force for actuating the mechanical metering pump of the cartridges;
   a selective transmission mechanism able selectively to transmit the force generated by the motor to at least one of the mechanical metering pumps of the cartridges;
a housing for a removable container intended to receive the fluid products contained in the cartridges accommodated in the N locations and actuated by the selective transmission mechanisms;
   characterized in that the longitudinal axes of the N locations are arranged substantially horizontally with respect to the direction of terrestrial gravity and in a staged manner so that the cartridges are, in use, parallel to one another and to the longitudinal axes of the locations, but offset along their longitudinal axes, so that a cartridge situated above a cartridge situated below it overlies it sufficiently for the ejection orifice of the cartridge located above to extend longitudinally beyond the cartridge situated below and is in vertical alignment with the housing for the removable container.

By fluid product is meant any product that can be dispensed by a mechanical metering pump equipping the cartridges.

According to particular embodiments:
the N locations are fixed and offset so that the cartridges are offset along their longitudinal axes in an activated position or in an inactivated position;
the N locations are aligned on a plane in the rest position in which no cartridge is activated, the N locations being able to slide relative to the frame along their longitudinal axis, and each connected to a movement in translation mechanism, the dispenser being programmed for selective activation of the mechanism for moving the location of a cartridge to be activated to offset it until the ejection orifice of the cartridge extends longitudinally beyond a cartridge located below it and is in vertical alignment with the removable container;
the longitudinal axis of the N locations has an angle of inclination between −20° and +20° inclusive relative to the horizontal, preferably between −15° and +15° inclusive;
each of the N cartridge locations may include a polarizer arranged so that, when a cartridge is inserted into a location, the product ejection orifice of its metering pump is oriented toward a center of the housing for a removable container, at an angle to the direction of terrestrial gravity between 0° and 80° inclusive, preferably between 20° and 65° inclusive, advantageously between 30° and 45° inclusive;
each location for a cartridge may be provided with a product cartridge the metering pump of which includes an ejection nozzle having a conical and outwardly flared product ejection portion;
the ejection nozzle may include a product decelerator in the flared end portion;
the decelerator may be a cone converging toward the exterior of the nozzle and retained in the nozzle and at a distance from the walls of the nozzle by support tongues;
the transmission mechanism may include:
   a transmission member;
   an actuation member; and
   N clutch mechanisms each including a clutch member reversibly activatable by a linear actuator, each clutch mechanism being adapted to couple or to uncouple the transmission member and the actuation member;
   a central unit programmed for selective actuation of each linear actuator as a function of a particular mixture preparation instruction; and/or
   the transmission member may be a transmission notched wheel connected to a rotatable output shaft of the motor, the N cartridges locations being arranged on either side of the actuation member, each cartridge location a being provided with:
   an actuation member including a cylindrical cam provided on the one hand with a driving notched wheel and on the other hand with a follower member connected to a piston for actuating the cartridge in translation; and
   a clutch mechanism including:
      a clutch notched wheel mounted to be mobile between a clutch engaged position in which the clutch notched wheel meshes with the driving notched wheel of the cam and with the transmission notched wheel of the motor and a clutch disengaged position in which the clutch notched wheel is disengaged from the transmission notched wheel of the motor;
      a solenoid adapted to drive movement of the clutch notched wheel between the clutch engaged position and the clutch disengaged position.

Another object of the invention is a fluid product cartridge for a dispenser as described above, the cartridge including a product reservoir and a mechanical pump provided with a product ejection orifice, said mechanical pump further including an ejection nozzle including a conical and outwardly flared product ejection portion.

According to particular embodiments:
the ejection nozzle may include a product decelerator in the flared end portion;
the decelerator is a cone converging toward the exterior of the nozzle and retained in the nozzle and at a distance from the walls of the nozzle by support tongues;
the cartridge may include an indication of the height of a location in the dispenser;
the cartridge may include a polarizer adapted to cooperate with a polarizer of a location to orient the cartridge about its longitudinal axis; and/or
the cartridge may include
a fluid product reservoir provided with a mechanical metering pump that can be activated in an axial actuation direction and has a product ejection orifice, and
a rigid envelope for protection of the reservoir and the pump, the rigid envelope including an outlet orifice intended to be connected to the ejection orifice of the pump), and at least one actuation orifice intended, in use, to receive an actuating member of the location of a cartridge, said at least one actuation orifice having a section smaller than the section of a finger of a three-year-old child.

The invention also has for object an ejection nozzle for a product cartridge as described above, the nozzle including an ejection portion having an outwardly flared interior face.

According to particular embodiments:
the ejection nozzle may further include a product decelerator in the flared ejection portion; and/or
the decelerator may be a cone converging toward the exterior of the nozzle and retained in the nozzle and at a distance from the walls of the nozzle by support tongues.

Another object of the invention is a method of using a dispensing device as described above, wherein:
the dispenser is placed on a plane surface;
a cartridge is disposed in each location so that the cartridges containing the least viscous products are arranged in the locations closest to the housing for the removable container and the cartridge containing the most viscous products are arranged in the locations at the greatest heightwise distance from the housing for the removable container.

In accordance with one particular embodiment, for a dispenser including cartridge locations mounted to slide relative to the frame along their longitudinal axis, the method may comprise the following steps:
a) In a first level of locations the dispenser moves the location of each cartridge the product from which is part of the particular composition by a distance such that its ejection orifice extends longitudinally beyond a cartridge situated below it and is in vertical alignment with the removable container, then
b) the dispenser actuates the cartridge or cartridges that have been moved in order to eject the products that they contain in the direction of the removable container, then
c) the dispenser actuates the movement mechanisms to replace the location of each cartridge that has been actuated in the rest position,
d) the dispenser repeats the steps a) to c) level by level of locations until all the cartridges the product in which is part of the particular composition have been actuated.

Other features of the invention will be set out in the following detailed description with reference to the appended figures, provided by way of example, that respectively represent:

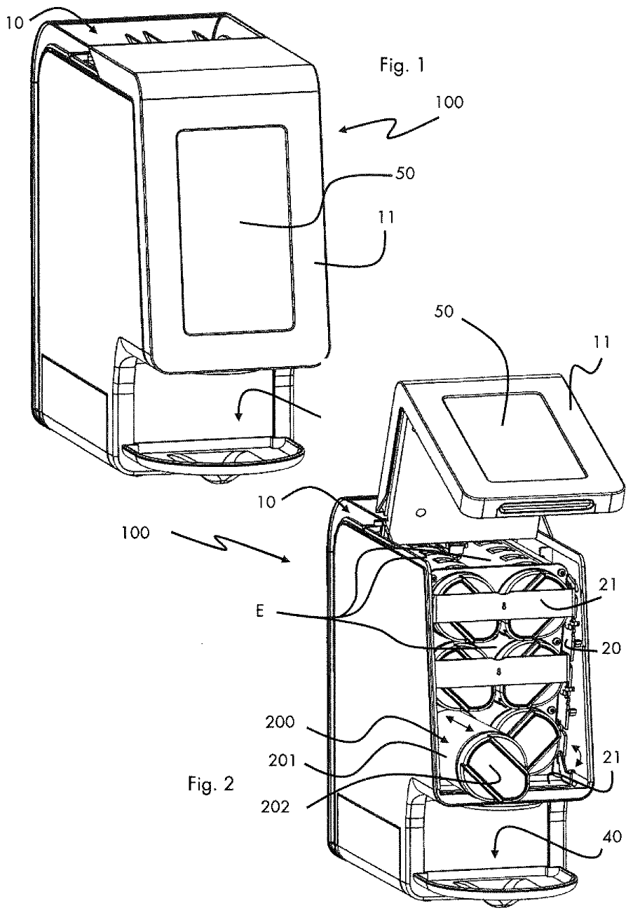

FIG. 1, a schematic perspective view of a first embodiment of an automatic dispenser according to the invention in closed position;

FIG. 2, a schematic view in perspective of the dispenser from FIG. 1 the front cover of which is open to show the cartridges arranged in the dispenser, one of the cartridges being in the process of being changed;

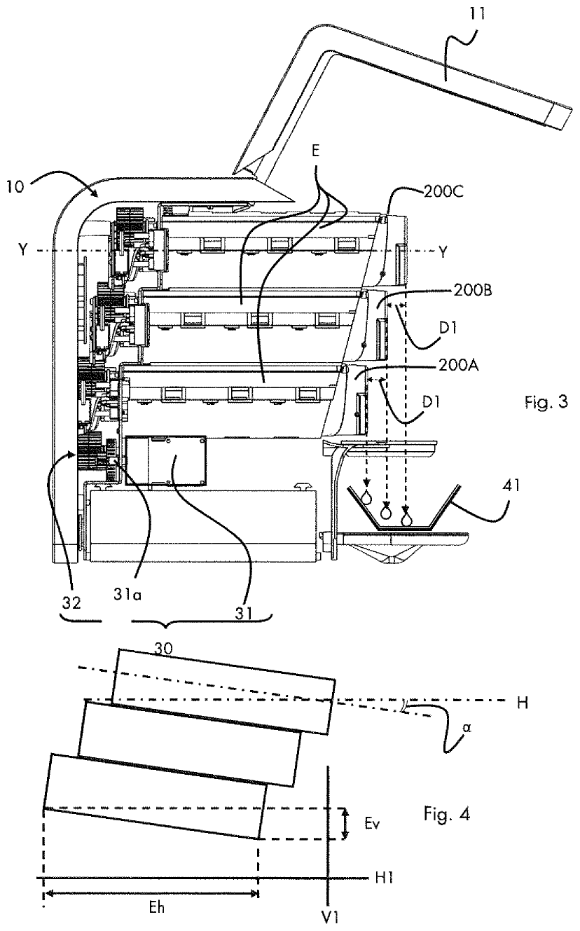

FIG. 3, a schematic side view of the dispenser from FIG. 2, in which the cartridge in the process of being changed has been inserted in a position of use, and a lateral cover of which has been removed to show the arrangement of the cartridges in accordance with the invention;

FIG. 4, a schematic view of a variant arrangement in accordance with the invention in which the locations are elongate but are at a small angle to the horizontal;

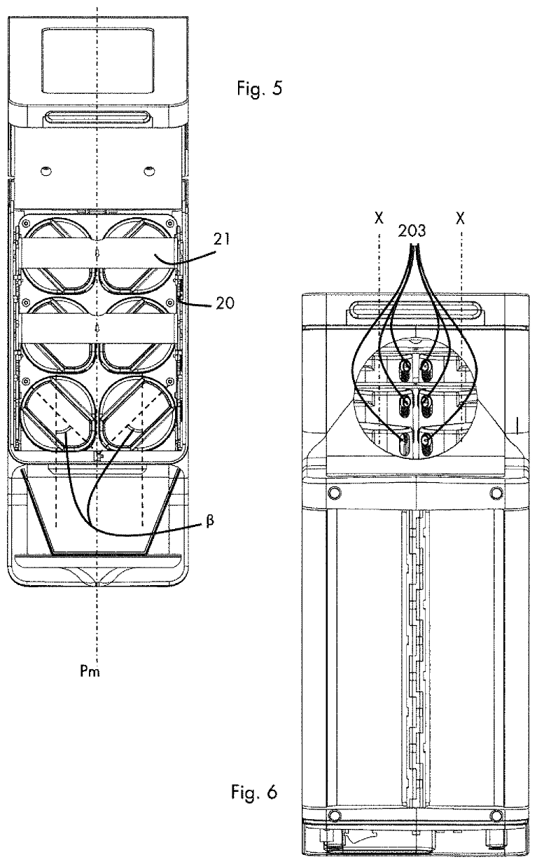

FIG. 5, a schematic front view of the dispenser from FIG. 3, showing that the cartridges are pivoted on themselves so that their product ejection orifice is directed toward a median plane of the dispenser;

FIG. 6, a schematic view from below of the dispenser from FIG. 3, showing that in this first embodiment the cartridges are offset axially from one level to another, even in a rest position;

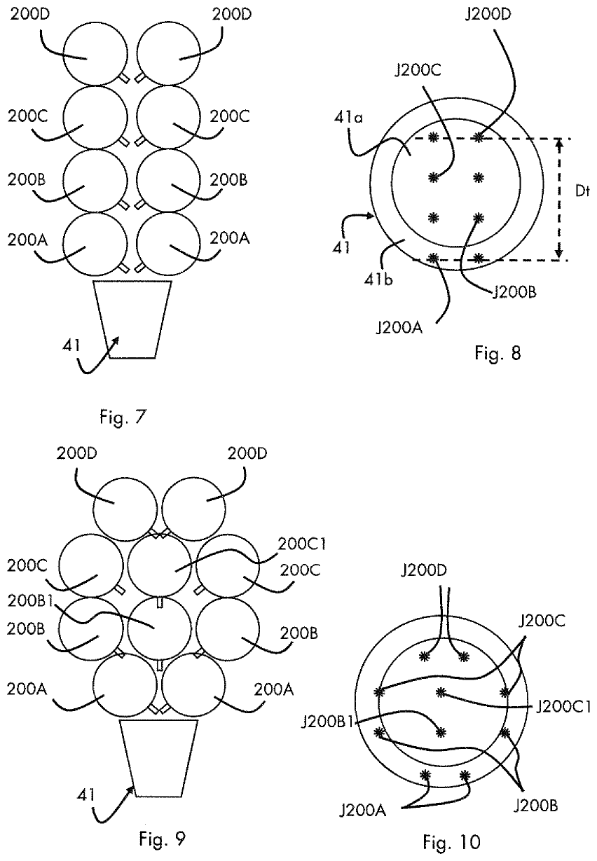

FIG. 7, a schematic front view of an arrangement in accordance with the invention with eight cartridges arranged in pairs on four levels and forming two identical columns;

FIG. 8, a schematic view from above of the impact of droplets in a container receiving the products from the cartridges of the arrangement from FIG. 7;

FIG. 9, a schematic front view of an arrangement in accordance with the invention with ten cartridges arranged in clusters on four levels;

FIG. 10, a schematic view from above of the impact of droplets in a container receiving the products from the cartridges of the arrangement from FIG. 9;

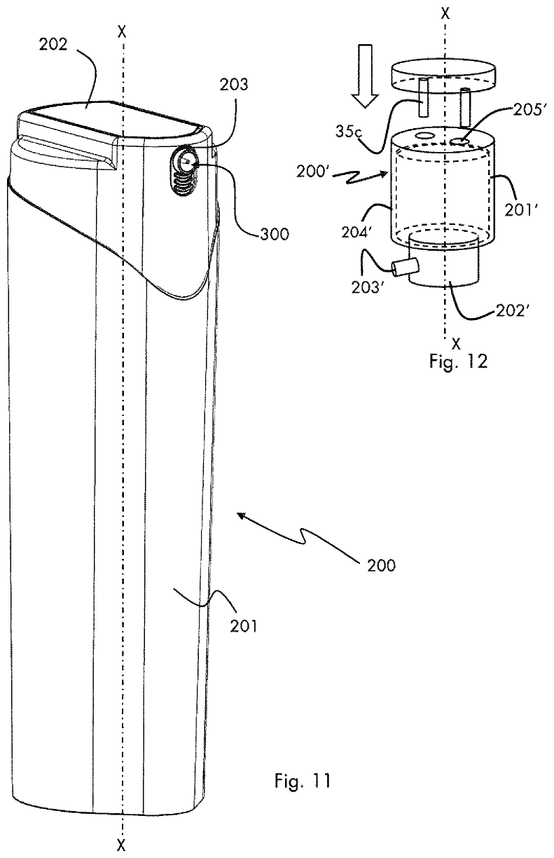

FIG. 11, a schematic perspective view of one embodiment of a cartridge for the dispenser according to the invention;

FIG. 12, a schematic perspective view of the mode of actuating an alternative cartridge embodiment usable in the dispenser according to the invention;

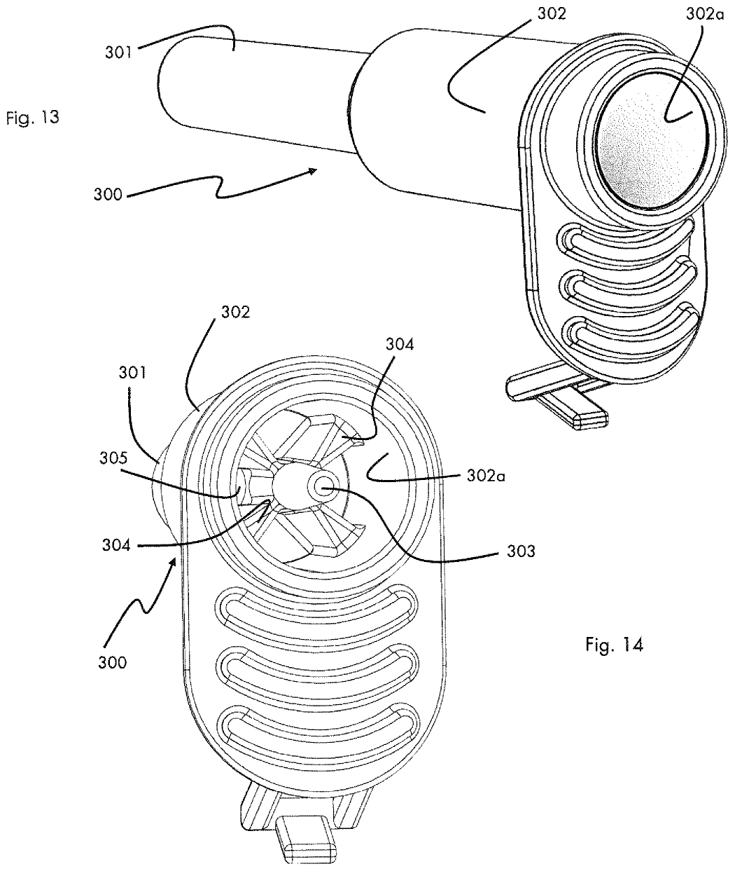

FIG. 13, a schematic perspective view of a first embodiment of an ejection nozzle according to the invention for the dispenser according to the invention;

FIG. 14, a schematic perspective view of an ejection nozzle according to the first embodiment of the invention, the nozzle including a flowrate decelerator;

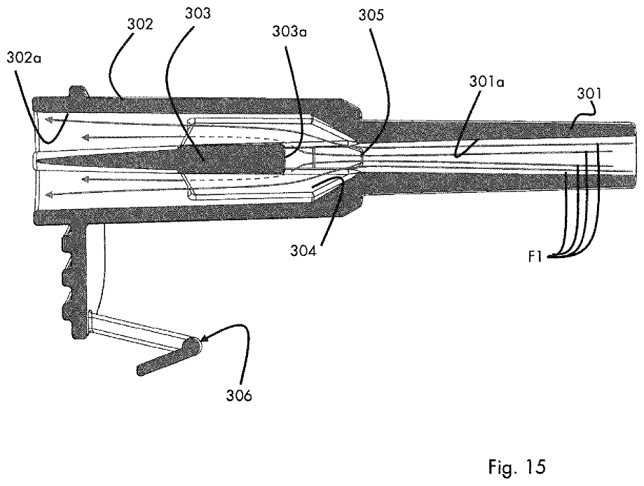

FIG. 15, a schematic view in longitudinal section of the ejection nozzle from FIG. 14 showing the path taken by the fluid product during ejection;

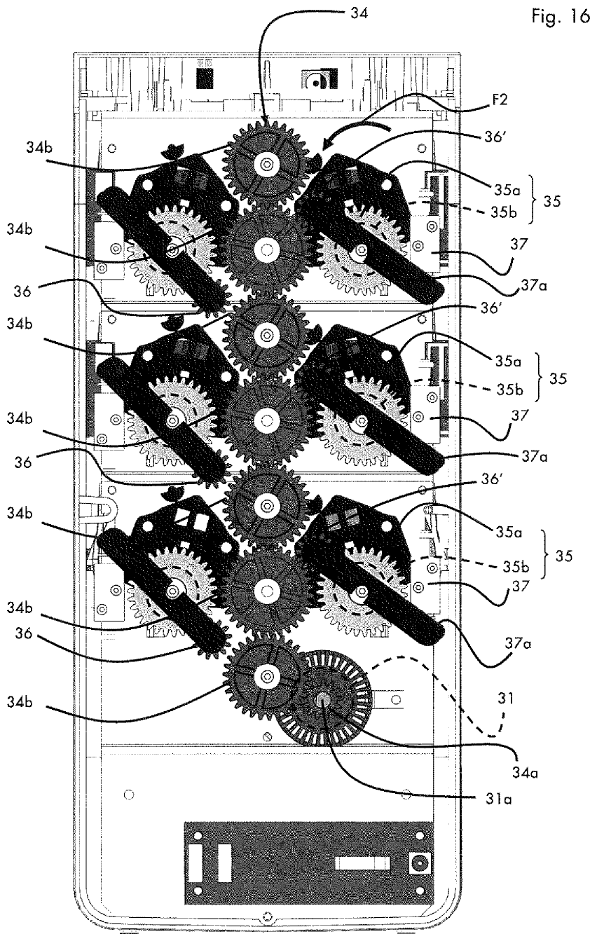

FIG. 16, a schematic rear view of one embodiment of a cartridge actuating system in which the transmission member, the actuating members and the clutch mechanisms include notched wheels;

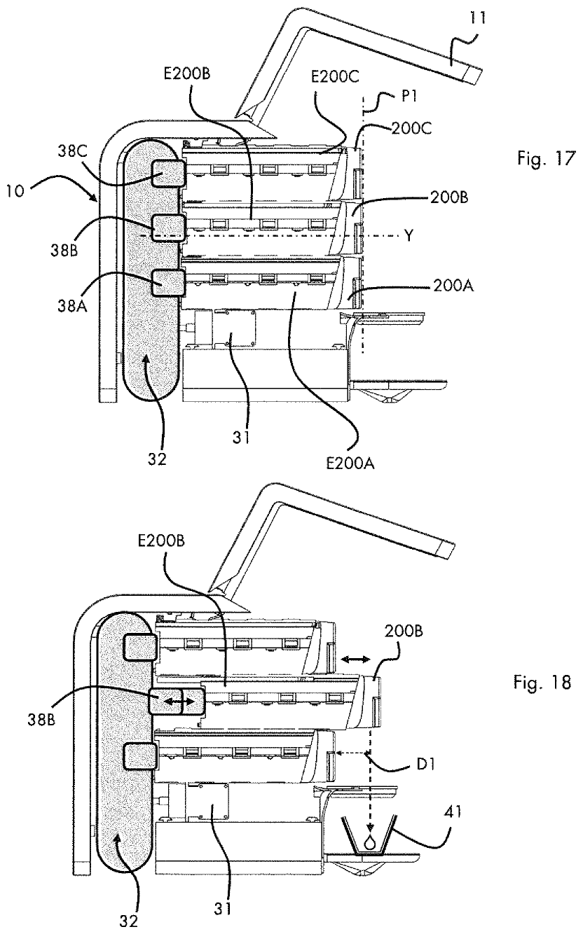

FIG. 17, a schematic perspective view of a second embodiment of an automatic dispenser according to the invention, in which the cartridges are aligned axially in a rest position, that is to say when they are not actuated; and

FIG. 18, a schematic perspective view of a second embodiment of an automatic dispenser from FIG. 17, in a cartridge activation position, in which said cartridge is offset axially relative to the other cartridges that are not actuated;

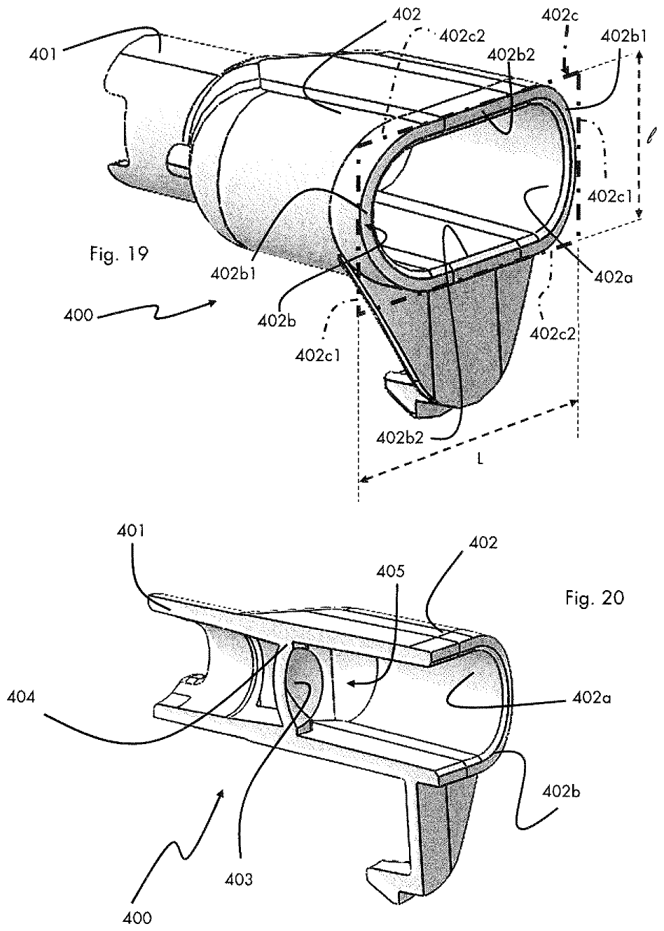

FIG. 19, a schematic perspective view of a second embodiment of an ejection nozzle according to the invention for the dispenser according to the invention;

FIG. 20, a schematic perspective view in section of the ejection nozzle from FIG. 19;

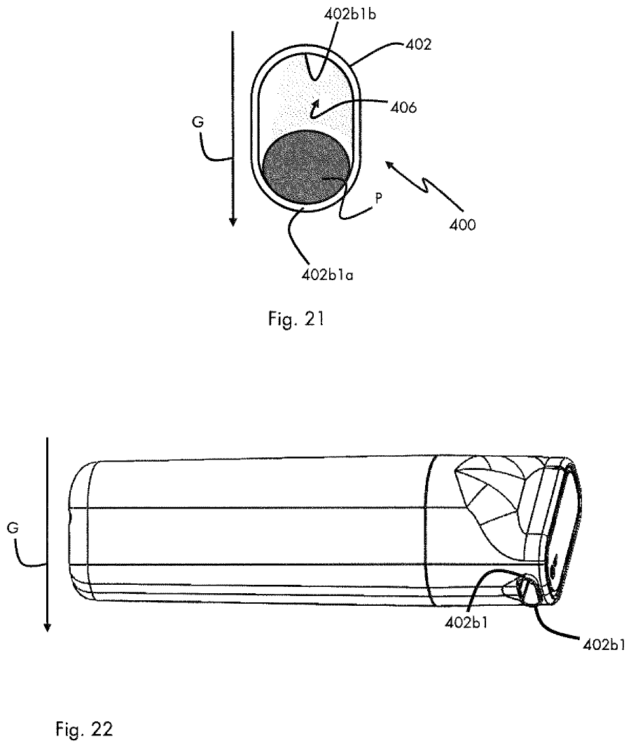

FIG. 21, a schematic front view, in a position of use, of the second embodiment of an ejection nozzle according to the invention; and

FIG. 22, a schematic perspective view of a cartridge in a position of use and equipped with the second embodiment of the ejection nozzle according to the invention for the dispenser according to the invention.

FIGS. 1 to 3 illustrate a first embodiment of an automatic dispenser 100 according to the invention.

Generally speaking, the dispenser 100 includes an exterior casing 10 in which are found a frame 20 with N locations E each having a longitudinal axis Y, N being an integer greater than or equal to 2.

N is an integer greater than or equal to 2, but of course the benefit of the invention is to provide more cartridge locations so as to be able to use more different products and to enable the dispensing of many more combinations of mixtures. Accordingly, thanks to the invention N is an integer that may be greater than or equal to at least 6, advantageously at least 8, even more advantageously at least 10.

In other words, the frame includes a rack part formed of compartments constituting the locations E. This rack may be an integral part of the frame or be fixed to the frame.

Each location E is intended to receive, in use, cartridges 200 of products that can be actuated mechanically, such as those illustrated in FIGS. 11 and 12. Accordingly, each cartridge 200-200′ includes a reservoir 201-201′ and a mechanical metering pump 202-202′ that can be activated in a substantially horizontal axial actuation direction X-X and include a product ejection orifice 203-203′. When a cartridge is inserted in a position of use in a location E the longitudinal axis Y of the location E and the longitudinal axis X-X of the cartridge 200 coincide.

This type of mechanically-actuated metering pump is for example described in the patents EP1572375 and EP2841206. The accuracy of metering is guaranteed by the metering pump, which dispenses a fixed volume when it is mechanically actuated, typically by linear pressure in the axial direction X-X of the pump. The volume delivered depends on the metering pump and it is therefore possible to equip a reservoir of standard shape with metering pumps with different ejection volumes.

By convention, in the remainder of the present description a cartridge according to the invention comprises a reservoir of fluid product provided with a mechanical metering pump enabling dispensing of a known dose by mechanical action on the reservoir (relative pressure between the reservoir and the pump). In some embodiments the cartridge may further comprise a rigid envelope in which are found the fluid product reservoir provided with the metering pump, the envelope including actuation orifices intended each to receive, in use, an actuation rod carried by the automatic dispenser for pressing the reservoir against the pump and commanding ejection of product.

The dispenser 100 also includes a system 30 for actuating the cartridges, including a motor 31 adapted to generate a force for actuating the mechanical metering pump 202 of the cartridges 200 and a selective transmission mechanism 32 adapted to transmit the force generated by the motor selectively to at least one of the mechanical metering pumps 202 of the cartridges 200. One embodiment of an actuating system of this kind will be described with reference to FIGS. 16-19.

The dispenser 100 also includes a housing 40 for a removable container 41 intended to receive the fluid products contained in the cartridges 200 accommodated in the N locations E and actuated by the selective transmission mechanism 32.

The dispenser 100 according to the invention also includes an interface 50 for controlling the dispenser. In FIG. 1 this interface 50 is a touch-sensitive screen carried by a pivoting cover of the exterior casing 10.

According to the invention the N locations E are arranged substantially horizontally with reference to the direction of terrestrial gravity. In other words, the locations E are substantially horizontal in a position of use, that is to say in a position for dispensing products contained in the cartridges accommodated in the locations E.

By substantially horizontal is to be understood that the projection Eh on a horizontal plane H1 of the locations E is very much larger than the projection Ev on a vertical plane V1 of the locations E, which can be zero.

The longitudinal axis Y of the N locations E preferably has an angle of inclination a between −20° and +20° inclusive relative to the horizontal H, preferably between −15° and +15°, advantageously between −10° and +10°.

The cartridges 200 may thus be slightly inclined so that they are not totally horizontal, but slightly inclined in order to control the position of the air present in the cartridge. This is particularly pertinent if airless cartridges are used. In fact, if a bubble is present in a horizontal airless cartridge, the latter will be directed toward the outlet at an uncontrolled moment and will lead to an incorrect dose.

Inclining the pump cartridge upward makes it possible to orient the bubbles toward the pump in order for them to be evacuated immediately in the first doses. This may be taken into account in an initialization step.

Moreover, a slight upward inclination of the pump is sufficient to prevent the disadvantages stemming from the distribution of products sensitive to the phenomenon of sedimentation since the particles that settle out are to be found at the opposite end of the cartridge to the pump.

Conversely, having the pump inclined downward drives the bubbles to the rear, with the result that the bubbles arrive at the pump only toward the end of the cartridge, which can equally be taken into account in the dispensing time of the cartridge.

Moreover, a slight downward inclination of the pump is sufficient to prevent the disadvantages stemming from the dispensing of products sensitive to the phenomenon of supernatation, since the supernatant particles are to be found at the opposite end of the cartridge from the pump.

Thus locations E slightly inclined upward for products containing particles that settle out may be combined with slightly downward inclined locations E for products containing supernatant particles. Alternatively, the locations E may be strictly horizontal and the cartridges have a pump arranged toward the center of the end face of the cartridge and not in a peripheral manner as is the case in the cartridges illustrated in the appended figures, with the result that in use the particles that settle out remain under the pump and the supernatant particles remain above the pump during most of dispensing, which can also be taken into account in the dispensing time of the cartridge.

Also in accordance with the invention the locations E are arranged in a staggered manner with the result that the cartridges are superposed and distributed over a plurality of levels. This distribution may be effected in one or more columns as illustrated in FIG. 7 or in a cluster as illustrated in FIG. 9.

In the first embodiment illustrated in FIGS. 1 to 6, the N locations E are fixed relative to the frame and are offset along their longitudinal axes Y-Y so that the cartridges are offset along their longitudinal axes (X-X) in an activated position (that is to say when the cartridges are actuated) or an inactivated position (that is to say when no cartridge is actuated). Accordingly, the cartridges are parallel to one another and parallel to the longitudinal axes Y-Y of the locations, but offset along their longitudinal axes X-X, by a distance D1 such that a cartridge 200B (respectively 200C) situated above a cartridge 200A (respectively 200B) situated below it overlies the cartridge situated below it sufficiently for the ejection orifice of the cartridge 200B (respectively 200C) located above it to extend longitudinally beyond the cartridge 200A (respectively 200B) situated below it and to be vertically in line with the removable container 41.

The distance D1 must be greater than half the maximum diameter of the outlet jet of the cartridge, this diameter being defined essentially by the shape of the ejection orifice or of the nozzle when the latter is provided with same.

Thanks to the arrangement according to the invention the number N of cartridge locations may be between 6 and 15 inclusive, preferably between 8 and 12 inclusive, whilst maintaining a limited footprint of the machine. The number of locations is then limited more by the cost and the bulk of the components of the actuating system (motor, number of actuators, power supply, etc.), especially if the dispenser is intended for domestic use.

In the embodiment illustrated in FIGS. 1 to 3 there are six locations E of cartridges 200 distributed in three rows of two cartridges 200. in a first embodiment with 100 milliliter cartridges each cartridge 200 is circumscribed in a cylinder of 47 mm diameter (23.5 mm radius), the two columns are 52 mm apart and two successive rows are 50 mm apart (from cartridge center to cartridge center), the offset between two rows being 18 mm. In a second example with 200 milliliter cartridges each cartridge 200 is circumscribed in a cylinder of 47 mm diameter (23.5 mm radius), the two columns are 59 mm apart and two successive rows are 62 mm apart (from cartridge center to cartridge center), the offset between two rows being 16 mm.

The elongate disposition of the cartridges further enables direct access to the cartridges and loading from the front by raising the cover 11. In order to enable both loading of the cartridges from the front and actuation of the cartridges in use the invention provides a locking system reversible between a loading position in which it enables withdrawal from and insertion in a cartridge in its housing and a position of use in which it holds the pump when the actuating system actuates the pump by applying pressure to the reservoir. Each location E includes at the front an inlet orifice of the cartridge and an abutment flap 21 pivoting between a position for loading/emptying the cartridge in which the flap 21 is retracted to free the inlet orifice and sliding of the cartridge into or out of the location E (see the flap 21a and the cartridge 200 being loaded in FIG. 2), and a position of use in which the flap 21 bears against the mechanical pump 202 of the cartridges. As illustrated in FIG. 2 the pivoting flap is advantageously common to all the locations E of the same level.

Alternatively, the front cover 11 may itself include on its interior face (not visible in FIG. 2) pump abutments that are in contact with the pumps of the cartridges. These two configurations may be combined, in which case the abutments are pressed against the flaps, which enables them to be reinforced.

Accordingly, to load or empty the cartridges it is sufficient to raise the cover 11, to pivot the pivoting abutment flaps 21 to enable sliding of the cartridges 200, and then to fold the flaps 21 into the position of use against the pumps 202 of the cartridges 200 and finally to close the cover. The flaps are preferably also connected to one or more return springs to prevent a flap inadvertently remaining in the open position. The return spring then enables return of the flap against the pump or pumps and actuation of the system for immobilizing the flaps in this position (for example by positioning them behind an abutment).

At no time does the user have access to the compartment of the actuation system during loading/emptying of the cartridges.

In an advantageous embodiment of the invention illustrated in FIGS. 5 and 6 the cartridges are oriented about their longitudinal axis X-X so that their ejection orifice is directed toward a center of the housing 40 for a removable container 41. This enables reduction of the distance between the ejection orifices of two cartridges of the same level and reduces the necessary width of the container 41.

Each of the N cartridge locations E preferably includes a polarizer arranged so that when a cartridge is inserted in a location the product ejection orifice of the metering pump of the cartridge is oriented toward a center of the housing for a removable container, at an angle β to the direction of terrestrial gravity between 0° and 80° inclusive, preferably between 20° and 65° inclusive, advantageously between 30° and 45° inclusive.

The polarizer may be a particular shape of the cartridge and therefore of the locations E such as that illustrated hereinafter.

Accordingly, as FIG. 6 shows, the ejection orifices 203 are offset axially along the axis X-X of the cartridges located between two different levels and they are close together in the same level thanks to the orientation of each cartridge toward a median plane Pm of the dispenser 100, that is to say toward a center of the housing 40 for the removable container 41. This therefore ensures that all the jets of products are directed toward the container, which limits the risk of a jet landing outside the container.

FIGS. 7 to 10 illustrate the benefit of orienting the ejection orifices of the cartridges toward the center of the location 40 and therefore toward the center of the removable container 41.

In FIG. 7 the cartridges are organized on 4 levels in each of which there are two cartridges. According to the invention the various affected levels of cartridges have an offset enabling the jet from an upper cartridge to pass in front of the lower cartridge and to land without obstacle in the container.

ln this embodiment, if a jet of product has a diameter of 5 to 10 mm an offset D1 of 15 mm between the cartridges is necessary to prevent a row of cartridges wetting that below them. Accordingly, 4 rows make possible a total offset Dt of 45 mm between the two rows that are the farthest apart, which is appropriate for a glass with a diameter of 60 mm.

In one advantageous embodiment of the invention the cartridges of the most viscous products (for example syrups) are placed at the highest level and the cartridges of the least viscous products at the lowest level.

This limits the splashes generated when the product falls. In fact, the more viscous a product, the less the risk of splashes on dropping.

To this end, the cartridges advantageously include an indication of the height at which to place them in the locations E of the dispenser Ito be more precise an indication of the height at which to place them in the rack part) in such a manner as to enable the user to comply with the preferred location and to limit splashes. Alternatively or in combination with this, the cartridges include an electronic microchip that can be read by the dispenser, the latter warning the user of the incorrect positioning of the cartridge if the height information stored in the microchip is incompatible with the location E chosen by the user.

It is also preferable if the housing 40 is slightly off-axis so that when the container is in place to receive the products the most viscous products fall onto the base of the container and the less viscous products fall onto inclined rims of the container, which further reduces the risk of splashes.

Accordingly, in FIG. 8, the jets J200D, J200C and J200B coming respectively from the highest cartridges 200D, 200C and 200B have landed on the bottom 41a of the container 41. In contrast, the jets J200A from the lowest cartridges 200A have landed on the inclined rim 41b of the container 41. The latter is advantageously chosen to have a rim at on angle of less than 45°0 to the vertical so that the jet lands with a low angle of incidence and does not bounce to cause splashes.

FIG. 9 illustrates an embodiment including ten cartridges in a cluster in which it is possible to place two or three cartridges per row.

In this instance with four levels, the rows of three cartridges can neither be all at the top or all at the bottom, because the jets would no longer be above the container.

It will also be noted that in this cluster configuration the cartridges are not oriented in the same manner in the sense that the injection orifices are at different angles to the vertical (that is to say the direction of terrestrial gravity in the position of use). Accordingly, the cartridges 200B1 and 200C1 arranged vertically in line with the median plane of the container 41 have a zero-orientation angle β whereas the cartridges J200A, J200B, J200 C and J200D offset relative to the median plane of the container 41 have an orientation angle β of 45° in this example. This enables good aiming of the jets J200B1 and J200B2 at the center of the container 41.

A table setting out the various possible configurations as a function of the number of cartridges and of the number of rows required in the device is illustrated below.

TABLE 1

| Number of | | | | | |
|---|---|---|---|---|---|
| cartridges | 6 | 7 | 8 | 8 | 10 |
| row 1 | 2 | 2 | 2 | 2 | 2 |
| row 2 | 2 | 3 | 3 | 2 | 3 |
| row 3 | 2 | 2 | 3 | 2 | 3 |
| row 4 | | | | 2 | 2 |

Row 1 is the lowest and row 4 is the highest.

It is to be noted that if there are only three rows the device will be less high and that if there are only rows of two cartridges the device will be narrower (smaller footprint).

Accordingly, in FIG. 10, the jets J200D from the highest cartridges 200D have landed on the bottom 41a of the container 41. The jets J200C and J200B from the cartridges 200C and 200B respectively have landed on the bottom 41a and on the rims of the container 41. Finally, the jets J200A from the lowest cartridges 200A have landed on the inclined edge 41b of the container 41.

FIG. 11 illustrates an advantageous embodiment of a product cartridge for the automatic dispenser according to the invention.

In addition to ifs composition as described above, the cartridge 200 is cylindrical and advantageously has a non-circular section enabling a polarizer function for the arrangement described with reference to FIGS. 5 and 6.

If the cartridges 200 have the shape illustrated and a content of 100 mL (see the last embodiment above) and have dimensions such that each cartridge is circumscribed in a cylinder of 47 mm diameter (23.5 mm radius), the liquid outlet orifice will be found at the edge and at 28.5 mm from the central axis. If the cartridges 200 are disposed in the device with an angle β of 30° relative to the vertical, the outlet orifices of two cartridges of the same row are 23.5 mm apart, which enables the liquid to drop into a 60 mm container.

The product may be ejected from the cartridge by pushing on the reservoir 201 so that the pump 202 bearing against the frame of the dispenser (in particular against the pivoting abutment flap 21) is actuated and the fluid product is ejected.

In one particular embodiment illustrated in FIG. 12 the cartridges 200′ are similar to the cartridges described in the patent application FR1914673. They include a reservoir 201′ of fluid product provided with a mechanical pump 202′ that can be actuated in an axial direction and a rigid envelope 204′ including at least one actuation orifice 205′ adapted, in use, to receive an actuation rod 35c (also referred to hereinafter as the “piston”) carried by the actuation system 30 for actuating the mechanical pump.

The actuation orifice 205′ has a section less than the section of a finger of a three-year-old child which prevents the child pressing on the reservoir with their fingers, even if the latter are thin, and manually triggering the dispensing of the product in the reservoir.

Of course, the person skilled in the art is in a position easily to assess the size of the fingers of a three-year-old child, which is a reference used in very many international standards with respect of safety, for example in systems for preventing trapping of fingers in car electric windows (see for example Hohendorff et al., Annals of Anatomy 192 (2010) 156-161). That study shows that the average diameter of the finger of a three-year-old child is greater than 9 millimeters for the smallest phalanx of the little finger, advantageously less than 6 millimeters, typically between 3 and 6 millimeters, and can be up to 15 millimeters for the index finger and the middle finger.

Whatever kind of cartridge is used (with or without a rigid protection envelope), the metering pump 202-202′ preferably includes an ejection orifice 203-203′ provided with an ejection nozzle 300 enabling reduction of the speed at which the product is ejected as it leaves the cartridge.

A first preferred embodiment of an ejection nozzle according to the invention is illustrated in FIGS. 13 to 15.

The nozzle 300 has a longitudinal body enabling its insertion in the ejection orifice of the pump 202 of the cartridge 200.

The nozzle 300 has a product inlet portion 301 and a product ejection portion 302 the interior surface 302a of which is conical and outwardly flared, which reduces the speed at which the product is ejected at constant flowrate and enables accurate aiming for dispensing the product by gravity into the container 41.

By conical is meant that the ejection portion has a generally conical shape, that is to say is inscribed in a cone. In the sense of the invention a cone is therefore a volume generated by a straight or curvilinear line passing through a fixed point, at least virtually (that is to say in line with the real volume of the ejection portion) and the base of which, that is to say the shape of the terminal section of the ejection portion, is a closed curve. That curve may be substantially circular, as in the embodiment from FIGS. 13 to 15, or oblong, as in the embodiment from FIGS. 19 to 22.

For example, in the embodiment from FIGS. 13 to 15 the nozzle may include an inlet portion 301 that is 15 mm long with an inlet inside diameter of 3 mm and an inside diameter of 2 mm at the level of the passage 305 connecting the inlet portion 301 and the ejection portion 302.

in this example the ejection portion 302 is 15 mm long and has an inside diameter of 5 mm at the level of the passage 305 and an inside diameter of 5.5 mm at the level of the outlet.

For example, for a fluid with a viscosity between 10-4 and 10-2 Pa·s inclusive, which reaches the nozzle at a speed of 18.8 cm/s (flowrate of 1.33 ml/second), the latter will exit the nozzle at a speed of 5.6 cm/s, which represents a 70% reduction in speed and enables the fluid to fall essentially by gravity into the container (the horizontal component of the trajectory of the fluid is therefore negligible).

In an advantageous embodiment illustrated in FIGS. 14 and 15 the ejection nozzle further includes a product decelerator 303 in the flared end portion 301.

In the embodiment illustrated the decelerator 303 is a cone converging toward the exterior of the nozzle and retained in the nozzle and at a distance from the interior wall 301b of the nozzle by support tongues 304.

In this way, when the product arrives from the product inlet portion 301 via the passage 305 connecting the inlet portion 301 and the ejection portion 302 it encounters the decelerator 303 (here the base of the cone, that is to say the widest part 303a of the cone 303) and is obliged to circumvent it by passing between the support tongues 304, as indicated by the arrows F1 in FIG. 15.

This further reduces the speed at which the product is ejected at the outlet of the nozzle until the product is able to fall vertically by gravity into the removable container 41.

The volume of the decelerator depends on the fluid that has to be ejected. In fact, the greater the area of contact of the decelerator with the fluid, the greater the tendency to hold back its flow through surface tension forces, which can therefore falsify the volume of product really ejected. Accordingly, the more viscous the fluid the less the decelerator must have a volume that projects from its base 303a. The decelerator may then take the form of a simple disk. In some cases the fluid is so viscous that a decelerator is of no use or even harmful.

To the contrary, when the fluid is not very viscous the contact area must be increased to slow the fluid, in combination with the base 303a and the flared surface 302a.

The nozzle 300 according to the invention has only a very slight harmful influence on the dead volume. In fact, this nozzle is inserted in the outlet orifice 203 of the pump, which reduces the volume that orifice 203 so that “dead” volume added by the nozzle is largely compensated by the volume eliminated in the end piece of the pump. The increase in the dead volume therefore remains moderate (less than 50%). The nozzle consequently has much greater advantage in slowing the fluid so that it drops vertically by gravity into the removable container 41.

The product inlet portion 301 has a conical interior surface 301a that converges slightly toward the product ejection portion 302. This arrangement is necessary when the nozzle is manufactured by injection molding to enable extraction from the mold. In this case it is therefore necessary to minimize this convergence angle to enable effective removal from the mold whilst limiting the acceleration of the product. In any event, this acceleration is very much less than the deceleration obtained by the flared ejection part 302 of the nozzle.

Of course, if the nozzle is manufactured by a technique other than molding (for example by 3D printing), the convergence of the inlet portion 301 may be zero.

In complementary manner the nozzle 300 advantageously includes additional means 306 for fixing it to the cartridge. This is particularly advantageous when the cartridge includes a rigid protection envelope, because this enables the nozzle to be held against the envelope and therefore enables regular and reproducible aiming of the product into the container 41.

In the embodiment illustrated, this additional fixing means 306 is an elastic tongue intended to be immobilized between the ejection orifice of the pump 202 and the rigid envelope 204′.

Thanks to the elongate arrangement of the cartridges proposed by the invention it is therefore possible to provide a dispenser taking up very little room on its support (that is to say having a small footprint). Accordingly, if it is required to increase the number of cartridges, this increases the height of the dispenser by only the diameter of a cartridge per level added, even if that level comprises a plurality of cartridges. With the first embodiment illustrated in FIGS. 1 to 6 the increasing width, that is to say of the footprint, is very small and essentially corresponds to the offset D1 per added level, that is to say a few millimeters.

The benefit of adding cartridges and therefore of offering more possible combinations is therefore very much greater than the disadvantage of slightly increasing the footprint. The second embodiment illustrated in FIGS. 17 and 18 and the third embodiment illustrated in FIG. 19 completely avoid the disadvantage of the increase in the footprint when the number of levels of substantially horizontal cartridges is increased.

Another very important advantage of the elongate arrangement of the cartridges is that the actuation system is shifted to the rear of the machine. It is therefore possible to provide an independent inspection cover and to access the mechanism without having to demount the cartridges and the frame.

Moreover, the mechanism employed for selective actuation of the cartridges is complex and highly aesthetic, with the result that it is possible, by providing a transparent inspection cover, to show this mechanism, like a transparent watch that exposes its mechanism.

The actuation system one embodiment of which is described hereinafter is advantageously a system conforming to that described in the patent application FR2000302.

Generally speaking, the actuating system includes a motor 31 with a rotating output shaft 31a able to generate a force for actuating the mechanical metering pump 202 of the cartridges 200 and a selective transmission mechanism 32 able selectively to transmit the force generated by the motor to at least one of the mechanical metering pumps 202 of the cartridges 200.

The transmission mechanism 32 includes:
a transmission member 34, consisting in this embodiment of a gear train secured to the shaft 31a of the motor 31 (illustrated in dashed line in FIG. 16), the gear train 34a being interengaged with a succession of flat notched wheels 34b meshing in one another;
an actuation member 35 including a notched wheel 35a fixed to a cylindrical cam 35b (illustrated in dashed line in FIG. 16 because arranged behind the notched wheel 35a) intended to cooperate with a follower member connected to a compression piston of the cartridge; and
N clutch mechanisms 36-36′, each including a clutch member 36 (here a notched wheel) that can be reversibly actuated by a linear actuator 37, each clutch mechanism being arranged in such a manner as to couple or uncouple the transmission member 34 and the actuation member 35.

Moreover, the gear train 34a connecting the shaft of the motor to the succession of notched wheels 34b is advantageously provided with a coding wheel system capable of measuring the speed of the motor in order to enable regulation of the speed of the latter if necessary.

To manage the use of this system the dispenser also includes a central unit programmed for selective actuation of each linear actuator 37 as function of a particular instruction for preparation of a mixture received via the interface 50 or via an Internet connection.

FIG. 16 illustrates an advantageous embodiment that enables a relatively compact actuating system to be obtained because of a relatively low height, but extending over the height of the dispenser.

The motor 31 is provided with a member 34 for transmission of the force generated by the motor to N actuator members 35 of the mechanical metering pump of the cartridges. In other words, the dispenser includes as many actuating members 35 as locations for cartridges of products.

According to the invention, the dispenser also includes N clutch mechanisms 36 (that is to say as many as locations for cartridges of products), each including a clutch member that can be actuated reversibly by a linear actuator 37. Each clutch mechanism 36 is arranged in such a manner as to couple or uncouple the transmission member 34 and an actuating member 35 either directly or indirectly.

In the present invention a linear actuator is a mechanical actuator capable of generating a linear, that is to say non-circular, force. Moreover, a linear actuator in the sense of the present invention has insufficient power for direct actuation of the mechanical metering pump of the cartridges.

A linear actuator 37 is preferably an electromagnet with a mobile core, more commonly known by an abuse of language as a solenoid. In the present description there is therefore meant by solenoid an electromagnet with a mobile core which consists of an assembly comprising a coil of electrically conductive wire and a ferromagnetic and therefore magnetizable rod mounted to slide along the axis of the coil to be moved in translation as a function of the current circulating in the coil.

Finally, the dispenser according to the invention includes a central unit (not illustrated) programmed for selective actuation of the solenoid 37 of each cartridge location as a function of a particular instruction for preparation of a mixture.

In this embodiment the transmission member is a succession of transmission notched wheels 34 connected to the rotary output shaft 31a of the motor and the N cartridge locations are arranged on either side of the succession of transmission notched wheels 34b.

Each cartridge location is provided with an actuating member 35 including a driving notched wheel 35a secured to a cylindrical cam 35b (illustrated in dashed line in FIG. 16 because arranged behind the notched wheel 35a), for example a helicoidal cam, bearing against a follower member (not visible in the figure) connected to a piston (not visible in the figure) for actuation of the cartridge in translation.

Each cartridge location is also provided with a clutch mechanism that includes a clutch notched wheel 36 mobile between a clutch engaged position and a clutch disengaged position.

In FIG. 16 the clutch notched wheels 36′ on the right in the figure are in the clutch engaged position, that is to say meshed with a transmission notched wheel 34b and a driving notched wheel 35a, and the clutch notched wheels 36 on the left in the figure are in the clutch disengaged position, that is to say disengaged from the corresponding transmission notched wheel 34b.

The clutch mechanism also includes a solenoid 37 for driving movement of the clutch notched wheel by means of a lever 37a between the clutch engaged position and the clutch disengaged position.

If the cartridge of a location has to be activated, that is to say the product that it contains has to be dispensed, the corresponding solenoid 37 goes to the clutch engaged position (on the right in FIG. 16). The solenoid 37 pulls on the pivoting lever 37a which moves the clutch notched wheel 36 in the direction of the arrow F2 until the clutch notched wheel 36 meshes with the transmission notched wheel 34b and with the driving notched wheel 35a of the cam.

The rotation of the motor is therefore transmitted to the driving notched wheel 35a, which begins to turn.

The driving notched wheel 35a being secured to the cylindrical cam (not visible in the figure), the latter also begins to turn, with the result that the cam follower slides in translation relative to the frame and to the cartridge location E.

The cam follower being secured to a piston, the latter also slides and presses on the bottom of the reservoir 201, applying a substantially horizontal pressure, thus crushing the pump 202 against the pivoting abutment flap 21 to eject a dose of product.

The dispenser may advantageously provide a demultiplication system for accelerating or to the contrary reducing the speed of rotation of the driving notched wheel 35a of the cam relative to the transmission notched wheel 34b of the motor 13.

The solenoids of each location can be commanded independently of one another by the central unit of the dispenser with the result that each cartridge can be engaged or disengaged by the clutch independently of the others.

The actuating system described therefore enables selective actuation of the cartridges. Moreover, it is relatively compact and may be arranged entirely at the rear of the dispenser, which enables it to be accessible directly thanks to a demountable rear cover. It is then not necessary to demount the rest of the dispenser (frame, cartridge locations and cartridges, etc.) to access the system and to maintain it or to repair it.

The example actuation system described is equally applicable to the second embodiment of the dispenser according to the invention described hereinafter.

FIG. 17 illustrates a second embodiment of an automatic dispenser according to the invention in which the cartridges are aligned axially in a rest position, that is to say when they are not actuated. In other words, in a rest position in which none of the cartridges is activated, because no dispenser of product has been commanded, the N locations E are aligned on a plane P1.

However, to enable dispensing by gravity into the removable container 41 of products contained in the cartridges located in the upper levels (from the second level inclusive), the invention provides for moving the cartridge locations that have to be activated.

To this end, the N locations E are mounted so as to slide relative to the frame along their longitudinal axis Y and each is connected to a movement in translation mechanism 38: in FIGS. 17 and 18 the location E200A is connected to a movement mechanism 38A, the location E200B is connected to a movement mechanism 38B, and the location E200C is connected to a movement mechanism 38C. Alternatively, the locations E of the first level may be fixed, which economizes on energy and saves costs. In this case they must be arranged so that the ejection orifice 230 of the cartridges that they contain is situated above the container (not necessarily strictly above the center to enable ejection of the product contained in the cartridges of the upper levels).

In this second embodiment the dispenser is programmed for selective actuation of the movement mechanism (here 38B) of the location (here E200B) of a cartridge (here 200B) that has to be activated to offset it by a sufficient distance Di (FIG. 18) for the ejection orifice 230 of the cartridge 200B to extend longitudinally beyond the cartridge situated below it and in vertical alignment with the removable container.

The movement distance D1 must be greater than half the maximum diameter of the outlet jet of the cartridge, that diameter being essentially defined by the shape of the ejection orifice or of the nozzle if the latter is provided with one.

The movement and the activation of the cartridges are effected level by level to save time, and not location by location. Thus the cartridges of the same level can be actuated at the same time, and then replaced in the rest position, that is to say aligned on the plane P1.

Accordingly, to prepare a mixture of products of particular composition the second embodiment is used as follows:
a) In a first level of locations E the dispenser moves the location E of each cartridge 200B the product from which is part of the particular composition by a distance Di such that its ejection orifice 203 extends longitudinally beyond a cartridge 200A situated below it and is in vertical alignment with the removable container 41, then
b) the dispenser actuates the cartridge or cartridges that have been moved in order to eject the product or products that it or they contain in the direction of the removable container 41, then
c) the dispenser actuates the movement mechanisms to replace the location E of each cartridge that has been actuated in the rest position.

The dispenser then repeats the steps a) to c) level by level of locations E until all the cartridges the product in which is part of the particular compensation have been actuated.

This embodiment enables an increase in the footprint of the dispenser to be avoided when the choice is made to increase the number of levels or cartridges. The only limit is then the height of the dispenser, which must remain reasonable if it is a dispenser for domestic use.

In accordance with embodiments that are not illustrated:

The automatic dispenser may further include an instrument for monitoring delivery of the dose enabling verification of the actuation of each pump and/or monitoring of the volume of fluid dispensed. For example, the monitoring instrument enabling the actuation of each pump to be verified is arranged in such a manner as to detect a stroke of the actuating member (of the cam or of the piston).

Alternatively or in combination with this the monitoring instrument enabling monitoring of the volume of fluid dispensed may be arranged in the location 40 intended to receive the container 41, in particular under that container. Accordingly, it is possible to weigh the doses of products received in the container and to compare them to setpoint data. In the event of too large a difference, the central unit may be programmed to shut down the dispenser and request maintenance. In combination with this, if the dispenser is connected to a communication network, the central unit may be programmed to alert the manager of the machine.

The automatic dispenser may equally include at each cartridge location an anti-soiling damper of the cartridge. For example, this damper may be fixed to the pivoting abutment flap and generate an alarm if it detects a stress greater than the stress received upon normal activation of the ejection pump of the cartridge.

A preferred second embodiment of an injection nozzle according to the invention is illustrated in FIGS. 19 to 22.

The nozzle 400 has a longitudinal body enabling its insertion in the ejection orifice 203 of the pump 202 of the cartridge 200.

The nozzle 400 includes a product entry portion 401 and a product ejection portion 402 the interior surface 402a of which is conical and outwardly flared, which reduces the speed at which the product is ejected at constant flowrate and enables accurate aiming when dispensing product by gravity into the container 41.

The nozzle 400 differs from the nozzles 300 in the shape of its ejection portion 402. In this second embodiment the terminal section 402b of the ejection portion is an oblong closed curve, that is to say the shape of the terminal section 402b of the ejection portion 402 is inscribed in a virtual rectangle 402c. In the example illustrated this oblong shape is a rectangle with the shorter sides rounded in a portion of a circle. Alternatively, this shape could be elliptical, ovoid or polygonal, provided that the length L of the terminal section 402b is greater than its width l. By convention, the oblong shape of the terminal section 402B includes two small flanks 402b1 corresponding to the shorter sides 402c1 of the virtual rectangle 402c and two large flanks 402b2 corresponding to the large sides 402c2 of the virtual rectangle 402c.

This oblong shape of the terminal section 402b at the outlet of the ejection portion 402 enables particularly effective use of the cartridges in the elongated position according to the invention. In fact, in the position of use, illustrated in FIG. 21, the nozzle 400 of the cartridges, seen from the front, is arranged in such a manner that a dose of product P flows in the ejection portion 402 of the nozzle along a first small flank 402b1a of the oblong shape of the ejection portion, leaving a free space 406 between the product P and a second small flank 402b1b opposite the first small flank 402b1a. This free space 406 enables air to fill the interior of the nozzle and prevents retention of the product by capillarity in the ejection portion. In other words, this free space enables droplets of products to fall by gravity, in the direction G, when the cartridges are elongate and their pump is actuated by the dispenser, whilst limiting the risk of the product remaining totally or partly in the ejection portion and therefore favoring the reproducibility of emission of doses of products, even in small volumes.

This oblong shape of the ejection end of the nozzle is therefore perfectly suited to the ejection of a dose of product by gravity and therefore to the use of a dispenser of products in accordance with the invention in which the cartridges are in elongate position. This oblong shape of the ejection end of the nozzle therefore contributes to enabling dispensing by gravity in a restricted dispensing zone and with precise metering by reproducible mechanical action of the dispenser on the cartridges, which the features of the product dispenser according to the invention also aim to enable.

Accordingly, as FIG. 22 shows, the terminal section 402b at the outlet of the ejection portion 402 is arranged so that the small flanks 402b1 of the terminal section 402b are one above the other relative to the direction G of gravity and the large flanks of 402b2 of the terminal section 402b are one beside the other relative to the direction G of gravity.

In other words, in the position of use, the length L of the ejection portion is parallel, in horizontal projection, to the direction G of gravity and the width l is perpendicular, in horizontal projection, to the direction G of gravity.

In an advantageous embodiment illustrated in FIG. 20 the ejection nozzle further includes a product decelerator 403 at the entry of the ejection portion 402.

In the embodiment illustrated the decelerator 403 is a dome the convex side of which is directed toward the product entry portion 401 and the concave side of which is directed toward the outlet of the ejection portion 402.

The decelerator 403 is retained in the nozzle and at a distance from the interior wall 401b of the nozzle by support tongues 404.

In this way, when the product arrives from the product entry portion 401 through the passage 405 connecting the entry portion 401 and the ejection portion 402 it encounters the decelerator 403 (here the convex side) and is obliged to circumvent it by passing between the support tongues 404.

This further slows the speed at which the product is ejected at the outlet of the nozzle until the product is able to fall vertically by gravity into the removable container 41.

The automatic dispenser according to the invention is therefore able to accommodate more than six different cartridges whilst limiting the footprint of the machine. In fact, the elongate arrangement of the cartridges makes it possible not only to stack a large number of cartridges but also to “spread” the actuation system over the full height of the dispenser, thereby limiting the depth of said actuation system and therefore the footprint of the machine.

In other words, the proposed arrangement makes it possible not only to limit the footprint of the cartridge storage part but also the footprint of the cartridge actuating part.

The automatic dispenser according to the invention is also able to dispense a plurality of different combinations of fluid products each contained in a different cartridge as it enables selective activation of the cartridges.

Moreover, the dispenser according to the invention enables precise metering by reproducible mechanical action of the dispenser on the cartridges.

Thanks to the proposed arrangement, the dispenser according to the invention is simple, economical and relatively compact, that is to say has a small footprint, whilst enabling a large number of products and combinations to be offered, and all this with cartridges of high capacity.

It is thus possible to propose treatments over several weeks without having to change the cartridges, which limits the risks of error and waste.

Moreover, it is multipurpose, that is to say the proposed arrangement enables design of a dispenser having between 6 and 12 cartridges.

The system according to the invention enables adaptation to all mechanical metering pumps, in particular to the various amplitudes of travel necessary for actuating the pumps. In fact, depending on the volume dispensed, the pumps have different actuation strokes. For example, for a given type of pump, a pump delivering a volume of 1 milliliter necessitates a travel amplitude of 7.5 millimeters, whereas a pump delivering a volume of 2 milliliters necessitates an amplitude of travel of 12 millimeters. The system according to the invention can therefore be easily sized as a function of the dispensing volume of the pumps used.

1. An automatic dispenser (100) of fluid products contained in cartridges (200, 200′), the dispenser including:
a frame (20) with N locations (E) each having a longitudinal axis (Y-Y), N being an integer greater or equal to 2, the locations being intended, in use, to receive the cartridges (200, 200′) of products each including a reservoir (201, 201′) and a mechanical metering pump (202, 202′) that can be activated in an axial actuation direction (X-X) and includes a product ejection orifice (203, 203′);
a system (30) for actuating the cartridges, including:
a motor (31) able to generate a force for actuating the mechanical metering pump (202, 202′) of the cartridges (200, 200′);
a selective transmission mechanism (32) able to selectively transmit the force generated by the motor to at least one of the mechanical metering pumps (202, 202′) of the cartridges (200, 200′);
a housing (40) for a removable container (41) intended to receive the fluid products contained in the cartridges accommodated in the N locations and actuated by the selective transmission mechanisms;
characterized in that the longitudinal axes (Y-Y) of the N locations (E) are arranged substantially horizontally with respect to the direction of terrestrial gravity and in a level manner so that the cartridges are, in use, parallel to one another and to the longitudinal axes (Y-Y) of the locations (E), but offset along their longitudinal (X-X), so that a cartridge situated above a cartridge situated below it overlies it sufficiently for the ejection orifice of the cartridge located above to extend longitudinally beyond the cartridge situated below and is in vertical alignment with the housing (40) for the removable container (41).

2. The automatic dispenser as claimed in claim 1, in which the N locations (E) are fixed and offset so that the cartridges are offset along their longitudinal axes (X-X) in an activated position or in an inactivated position.

3. The automatic dispenser as claimed in claim 1, in which the N locations (E) are aligned on a plane (P1) in the rest position in which no cartridge is activated, the N locations (E) being able to slide relative to the frame along their longitudinal axis (Y), and each connected to a movement in translation mechanism, the dispenser being programmed for selective activation of the mechanism for moving the location (E200B) of a cartridge to be activated to offset it until the ejection orifice of the cartridge extends longitudinally beyond a cartridge located below it and is in vertical alignment with the removable container.

4. The automatic dispenser as claimed in claim 1, in which the longitudinal axis of the N locations (E) has an angle of inclination (α) between −20° and +20° inclusive relative to the horizontal, preferably between −15° and +15° inclusive.

5. The automatic dispenser as claimed in claim 1, in which each of the N cartridge locations includes a polarizer arranged so that, when a cartridge is inserted into a location, the product ejection orifice of its metering pump (203, 203′) is oriented toward a center of the housing (40) for a removable container, at an angle (β) to the direction of terrestrial gravity between 0° and 80° inclusive, preferably between 20° and 65° inclusive, advantageously between 30° and 45° inclusive.

6. The automatic dispenser as claimed in claim 1, in which each location (E) for a cartridge (200, 200′) is provided with a product cartridge (200, 200′) the metering pump of which includes an ejection nozzle (300) having a conical and outwardly flared product ejection portion (302).

7. The automatic dispenser as claimed in claim 6, in which the ejection nozzle includes a product decelerator (303) in the flared end portion.

8. The automatic dispenser as claimed in claim 7, in which the decelerator (303) is a cone converging toward the exterior of the nozzle and retained in the nozzle and at a distance from the walls of the nozzle by support tongues (304).

9. The dispenser as claimed in claim 1, in which the transmission mechanism includes:
a transmission member (34, 34b);
an actuation member (35, 35a); and
N clutch mechanisms each including a clutch member (36, 36′) reversibly activatable by a linear actuator (37-37a), each clutch mechanism being adapted to couple or to uncouple the transmission member (34, 34b) and the actuation member (35, 35a);
a central unit programmed for selective actuation of each linear actuator (37-37a) as a function of a particular mixture preparation instruction.

10. The automatic dispenser as claimed in claim 9, in which the transmission member is a transmission notched wheel (34a) connected to a rotatable output shaft (31a) of the motor (30), the N locations (E) of cartridges (200) being arranged on either side of the actuation member (34, 34b), each location (E) of a cartridge (200) being provided with:
an actuation member including a cylindrical cam provided on the one hand with a driving notched wheel (35a) and on the other hand with a follower member connected to a piston for actuating the cartridge in translation; and
a clutch mechanism including:
a clutch notched wheel (36, 36′) mounted to be mobile between a clutch engaged position in which the clutch notched wheel (36, 36′) meshes with the driving notched wheel (35a) of the cam and with the transmission notched wheel (34a) of the motor and a clutch disengaged position in which the clutch notched wheel (36, 36′) is disengaged from the transmission notched wheel (34a) of the motor;
a solenoid (37) adapted to drive movement of the clutch notched wheel (36, 36′) between the clutch engaged position and the clutch disengaged position.

11. A fluid product cartridge for a dispenser as claimed in claim 1, characterized in that it includes a product reservoir (201) and a mechanical pump (202) provided with a product ejection orifice (203), said mechanical pump further including an ejection nozzle (300, 400) including a conical and outwardly flared product ejection portion (302, 402).

12. The cartridge as claimed in claim 11 in which the ejection portion (402) includes an oblong terminal section (402b).

13. The cartridge as claimed in claim 11, in which the ejection nozzle includes a product decelerator in the flared end portion.

14. The cartridge as claimed in claim 12, in which the decelerator is a cone converging toward the exterior of the nozzle and retained in the nozzle and at a distance from the walls of the nozzle by support tongues.

15. The cartridge as claimed in claim 12, in which the decelerator is a dome maintained in the nozzle and at a distance from the walls of the nozzle by support tongues.

16. The cartridge as claimed in claim 11, including an indication of the height of a location in the dispenser.

17. The cartridge as claimed in claim 11, including a polarizer adapted to cooperate with a polarizer of a location to orient the cartridge about its longitudinal axis.

18. The cartridge as claimed in claim 11, in which each cartridge (200′) includes:
a fluid product reservoir (201′) provided with a mechanical metering pump (202′) that can be activated in an axial actuation direction (X-X) and has a product ejection orifice (203′), and
a rigid envelope (204′) for protection of the reservoir (201′) and the pump (202′), the rigid envelope including an outlet orifice intended to be connected to the ejection orifice (203′) of the pump (202′), and at least one actuation orifice (205′) intended, in use, to receive an actuating member (35c) of the location (E) of a cartridge (200′), said at least one actuation orifice (205′) having a section smaller than the section of a finger of a three-year-old child.

19. An ejection nozzle (300, 400) for a product cartridge as claimed in claim 11, characterized in that it includes an ejection portion (302, 402) having an outwardly flared interior face (302a, 402a).

20. The ejection nozzle as claimed in claim 19, in which the ejection portion (402) includes an oblong terminal section (402b).

21. The ejection nozzle as claimed in claim 19, further including a product decelerator (303, 403) in the flared ejection portion.

22. The ejection nozzle as claimed in claim 21, in which the decelerator (303) is a cone converging toward the exterior of the nozzle and retained in the nozzle and at a distance from the walls of the nozzle by support tongues (304).

23. A method of using a dispensing device as claimed in claim 1, characterized in that:
the dispenser (100) is placed on a plane surface;
a cartridge (200) is disposed in each location (E) so that the cartridges containing the least viscous products are arranged in the locations closest to the housing (40) for the removable container (41) and the cartridge containing the most viscous products are arranged in the locations at the greatest heightwise distance from the housing (40) for the removable container (41).

24. A method of using a dispensing device as claimed in claim 3 to prepare a mixture of products of particular composition, characterized in that:
a) In a first level of locations (E) the dispenser moves the location (E) of each cartridge (200B) the product from which is part of the particular composition by a distance (D1) such that its ejection orifice (203) extends longitudinally beyond a cartridge (200A) situated below it and is in vertical alignment with the removable container (41), then
b) the dispenser actuates the cartridge or cartridges that have been moved in order to eject the products that it contains in the direction of the removable container (41), then
c) the dispenser actuates the movement mechanisms to replace the location (E) of each cartridge (200B) that has been actuated in the rest position,
d) the dispenser repeats the steps a) to c) level by level of locations (E) until all the cartridges the product in which is part of the particular composition have been actuated.
